(19) United States
(12) Patent Application Publication
(10) Pub. No.: US 2013/0203003 A1
(43) Pub. Date: Aug. 8, 2013

(54) Low NOx Fuel Injection for an Indurating Furnace

(71) Applicants: Bruce E. Cain, Akron, OH (US); Thomas F. Robertson, Medina Township, OH (US); Mark C. Hannum, Hudson, OH (US); Todd A. Miller, Garfield Hts., OH (US); Joseph P. Brown, Akron, OH (US)

(72) Inventors: Bruce E. Cain, Akron, OH (US); Thomas F. Robertson, Medina Township, OH (US); Mark C. Hannum, Hudson, OH (US); Todd A. Miller, Garfield Hts., OH (US); Joseph P. Brown, Akron, OH (US)

(21) Appl. No.: 13/571,424

(22) Filed: Aug. 10, 2012

Related U.S. Application Data
(60) Provisional application No. 61/521,904, filed on Aug. 10, 2011.

(51) Int. Cl. C22B 1/24; F27B 9/36; F27B 9/24

(52) U.S. Cl. CPC C22B 1/2413; F27B 9/24; F27B 9/36
USPC 432/11; 432/152; 432/186

(57) ABSTRACT

A method delivers fuel gas to a furnace combustion chamber from a premix burner having a reaction zone with an outlet to the furnace combustion chamber. This includes the steps of injecting a premix of primary fuel gas and combustion air into the reaction zone, and combusting the premix to provide combustion products including vitiated combustion air in the reaction zone. Further steps include injecting staged fuel gas into the reaction zone separately from the premix, discharging the staged fuel gas and vitiated combustion air from the reaction zone through the outlet to the furnace combustion chamber, and combusting the staged fuel gas and vitiated combustion air in the furnace combustion chamber. This enables low NOx combustion in the furnace combustion chamber to be achieved as a result of interacting the staged fuel gas with the vitiated combustion air in the reaction zone.

### RELATED APPLICATIONS

This application claims the benefit of provisional U.S. patent application 61/521,904, filed Aug. 10, 2011, which is incorporated by reference.

### TECHNICAL FIELD

This technology relates to a heating system in which combustion produces oxides of nitrogen (NOₓ), and specifically relates to a method and apparatus for suppressing the production of NOₓ in an indurating furnace.

### BACKGROUND

Certain industrial processes, such as heating a load in a furnace, rely on heat produced by the combustion of fuel and oxidant. The fuel is typically natural gas. The oxidant is typically air, vitiated air, oxygen, or air enriched with oxygen. Combustion of the fuel and oxidant causes NOₓ to result from the combination of oxygen and nitrogen.

An indurating furnace is a particular type of furnace that is known to produce high levels of NOₓ. Large quantities of pelletized material, such as pellets of iron ore, are advanced through an indurating process in which they are dried, heated to an elevated temperature, and then cooled. The elevated temperature induces an oxidizing reaction that hardens the material. When cooled, the indurated pellets are better able to withstand subsequent handling in storage and transportation.

The indurating furnace has sequential stations for the drying, heating, and cooling steps. Pelletized material is conveyed into the furnace, through the sequential stations, and outward from the furnace. Air shafts known as downcomers deliver downdrafts of preheated air to the heating stations. Burners at the downdrafts provide heat for the reaction that hardens the pelletized material.

An example of a pelletizing plant 10 with an indurating furnace 20 is shown schematically in FIG. 1. A movable grate 24 conveys loads of pelletized material 26 into the furnace 20, through various processing stations within the furnace 20, and then outward from the furnace 20. The processing stations include drying, heating, and cooling stations. In this particular example, the drying stations include an updraft drying station 30 and a downdraft drying station 32. The heating stations include preheat stations 34 and firing stations 36. First and second cooling stations 38 and 40 are located between the firing stations 36 and the furnace exit 42. Burners 44 are arranged at the preheating and firing stations 34 and 36.

A blower system 50 drives air to circulate through the furnace 20 along the flow paths indicated by the arrows shown in FIG. 1. As the pelletized material 26 advances from the firing stations 36 toward the exit 42, it is cooled by the incoming air at the first and second cooling stations 38 and 40. This causes the incoming air to become heated before it reaches the burners 44. The preheated air at the second cooling station 40 is directed through a duct system 52 to the updraft drying station 30 to begin drying the material 26 entering the furnace 20. The preheated air at the first cooling station 38, which is hotter, is directed to the firing and preheat stations 36 and 34 through a header 54 and downcomers 56 that descend from the header 52. Some of that preheated air, along with products of combustion from the firing stations 36, is circulated through the downdraft drying station 32 before passing through a gas cleaning station 58 and onward to an exhaust stack 60.

As shown for example in FIG. 2, each downcomer 54 defines a vertical passage 61 for directing a downdraft 63 from the header 52 to an adjacent heating station 36. Each burner 44 is arranged to project a flame 65 into a downcomer 54. Specifically, each burner 44 is mounted on a downcomer wall 66 in a position to project the flame 65 in a direction extending across the vertical passage 61 toward the heating station 36 to provide heat for the reaction that hardens the pelletized material 26.

The burner 44 of FIG. 2 is an inspirating burner, which injects fuel and ambient temperature primary air. Some of the preheated air from the downdraft 63 is inspirated by the fuel and primary air through an inspirator 68. The fuel, primary air, and inspirated air form a fuel-rich diffusion-type flame which propagates into the downdraft 63, where the large excess of air in the downdraft 63 results in an overall ratio that is highly fuel lean, and thus high in oxygen content. This propagation of a fuel-rich diffusion-type flame into a highly preheated excess of combustion air produces high levels of interaction NOx as the unmixed or poorly mixed fuel interacts with the high temperature downdraft air in a fuel-lean atmosphere with a large excess of oxygen.

### SUMMARY

A method and apparatus achieve low NOx combustion of fuel gas in a furnace combustion chamber. In the preferred embodiments, the furnace combustion chamber is a downcomer passage in an indurating furnace.

The method delivers fuel gas to the furnace combustion chamber from a premix burner having a reaction zone with an outlet to the furnace combustion chamber. This includes the steps of injecting a premix of primary fuel gas and combustion air into the reaction zone, preferably injecting radial fuel gas into the reaction zone in a direction radially outward from an axis, and combusting those reactants to provide combustion products including vitiated combustion air in the reaction zone. Further steps include separately injecting staged fuel gas into the vitiated combustion air in the reaction zone, discharging the staged fuel gas and vitiated combustion air from the reaction zone through the outlet to the furnace combustion chamber, and combusting the staged fuel gas and vitiated combustion air in the furnace combustion chamber. This enables low NOx combustion in the furnace combustion chamber to be achieved as a result of interacting the staged fuel gas with the vitiated combustion air in the reaction zone.

The apparatus includes a burner structure defining a reaction zone with an outlet to the furnace combustion chamber. A mixer tube has an inlet connected to sources of primary fuel gas and combustion air, and has an outlet to the reaction zone. The apparatus preferably further includes a radial flame burner connected to sources of radial fuel gas and combustion air, and arranged to fire into the reaction zone. A staged fuel injector is connected to a source of staged fuel gas, and is arranged to inject the staged fuel gas into the reaction zone separately from the other injected reactants. The staged fuel gas can thus interact with vitiated combustion air in the reaction zone to produce low NOx combustion in the furnace combustion chamber.

### BRIEF DESCRIPTION OF THE DRAWINGS

FIG. 1 is a schematic view of a pelletizing plant including an indurating furnace known in the prior art.

FIG. 2 is an enlarged partial view of parts of the prior art indurating furnace of FIG. 1.

FIGS. 3 and 4 are schematic views similar to FIG. 2, but show embodiments of an indurating furnace that are not known in the prior art.

FIGS. 5-8 are similar to FIGS. 3 and 4, showing alternative embodiments of an indurating furnace.

FIGS. 9-13 show other alternative embodiments of an indurating furnace with elements of the present invention.

### DETAILED DESCRIPTION

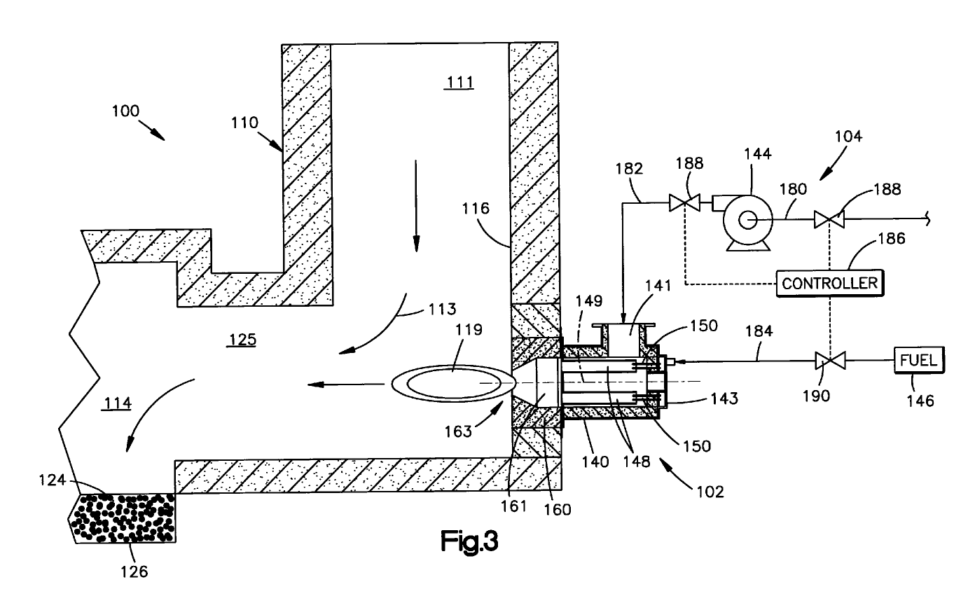

As shown partially in FIG. 3, an indurating furnace 100 is equipped with burners 102, one of which is shown in the drawing. The furnace 100 also has a reactant supply and control system 104 for operating the burners 102. The furnace 100 is thus configured according to the invention disclosed and claimed in copending U.S. patent application Ser. No. 12/555,515, filed Sep. 2, 2009, which is commonly owned by the Assignee of the present application. The furnace 100 may otherwise be the same as the furnace 20 described above, with downcomers 110 defining vertical passages 111 for directing downdrafts 113 from a header to adjacent heating stations 114. As set forth in the copending application, each burner 102 is mounted on a corresponding downcomer wall 116 in a position to project a premix flame 119 into the downdraft 113 in a direction toward the heating station 114. This provides heat for a reaction that hardens pelletized material 124 on a movable grate 126 at the heating station 114.

In the illustrated embodiment, the flame 119 is projected across the downcomer 110 toward a toward a horizontal lower end section 125 of the vertical passage 111 that terminates adjacent to the heating station 114. Although the illustrated downcomer 110 has a predominantly vertical passage 111, any suitable arrangement or combination of differently oriented passages for conveying a preheated recirculation air draft to an indurating heating station may be utilized.

The burners 102 are preferably configured as premix burners with the structure shown in the drawing. This burner structure has a rear portion 140 defining an oxidant plenum 141 and a fuel plenum 143. The oxidant plenum 141 receives a stream of unheated atmospheric air from a blower system 144. The fuel plenum 143 receives a stream of fuel from the plant supply of natural gas 146.

Mixer tubes 148 are located within the oxidant plenum 141. The mixer tubes 148 are preferably arranged in a circular array centered on a longitudinal axis 149. Each mixer tube 148 has an open inner end that receives a stream of combustion air directly from within the oxidant plenum 141. Each mixer tube 148 also receives streams of fuel from fuel conduits 150 that extend from the fuel plenum 143 into the mixer tube 148. These streams of fuel and combustion air flow through the mixer tubes 148 to form a combustible mixture known as premix.

An outer portion 160 of the burner 102 defines a reaction zone 161 with an outlet port 163. The premix is ignited in the reaction zone 161 upon emerging from the open outer ends of the mixer tubes 148. Ignition is initially accomplished by use of an igniter before the reaction zone 161 reaches the auto-ignition temperature of the premix. Combustion proceeds as the premix is injected from the outlet port 163 into the downcomer 110 to mix with the downdraft 113. The fuel in the premix is then burned in a combustible mixture with both premix air and downdraft air. By mixing the fuel with combustion air to form premix, the burner 102 avoids the production of interaction NOₓ that would occur if the fuel were unmixed or only partially mixed with combustion air before mixing into the downdraft air.

As further shown in FIG. 3, the reactant supply and control system 104 includes a duct 180 through which the blower system 144 receives unheated air from the ambient atmosphere. Another duct 182 extends from the blower system 144 to the oxidant plenum 141 at the burner 102. A fuel line 184 communicates the fuel source 146 with the fuel plenum 143 at the burner 102. Other parts of the system 104 include a controller 186, oxidant control valves 188, and fuel control valves 190.

The controller 186 has hardware and/or software that is configured for operation of the burner 102, and may comprise any suitable programmable logic controller or other controlled device, or combination of controlled devices, that is programmed or otherwise configured to perform as described and claimed. As the controller 186 carries out those instructions, it operates the valves 188 and 190 to initiate, regulate, and terminate flows of reactant streams that cause the burner 102 to fire the premix flame 119 into the downcomer 110. The controller 186 is preferably configured to operate the valves 188 and 190 such that the fuel and combustion air are delivered to the burner 102 in amounts that form premix having a lean fuel-to-oxidant ratio. The fuel-lean composition of the premix helps to avoid the production of interaction NOₓ in the downdraft 113.

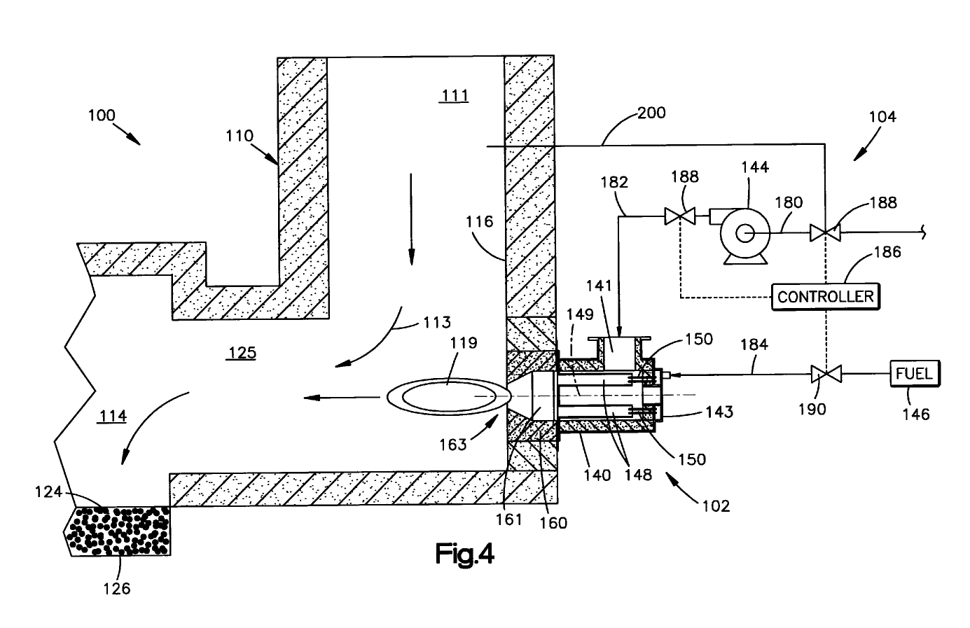

Although the premix produces less interaction NOₓ upon combustion of the fuel-air mixture in the high temperature downdraft 113, this has an efficiency penalty because it requires more fuel to heat the cold atmospheric air in the premix. The efficiency penalty is greater if the premix has excess air to establish a lean fuel-to-oxidant ratio. However, the efficiency penalty can be reduced or avoided by using an embodiment of the invention that includes preheated air in the premix. For example, in the embodiment shown in FIG. 4, the reactant supply and control system 104 includes a duct 200 for supplying the burner 102 with preheated downdraft air from the downcomer 110. As in the embodiment of FIG. 3, the controller 186 in the embodiment of FIG. 4 is preferably configured to operate the valves 188 and 190 such that the fuel gas, the unheated air, and the preheated air are delivered to the burner 102 in amounts that form premix having a lean fuel-to-oxidant ratio.

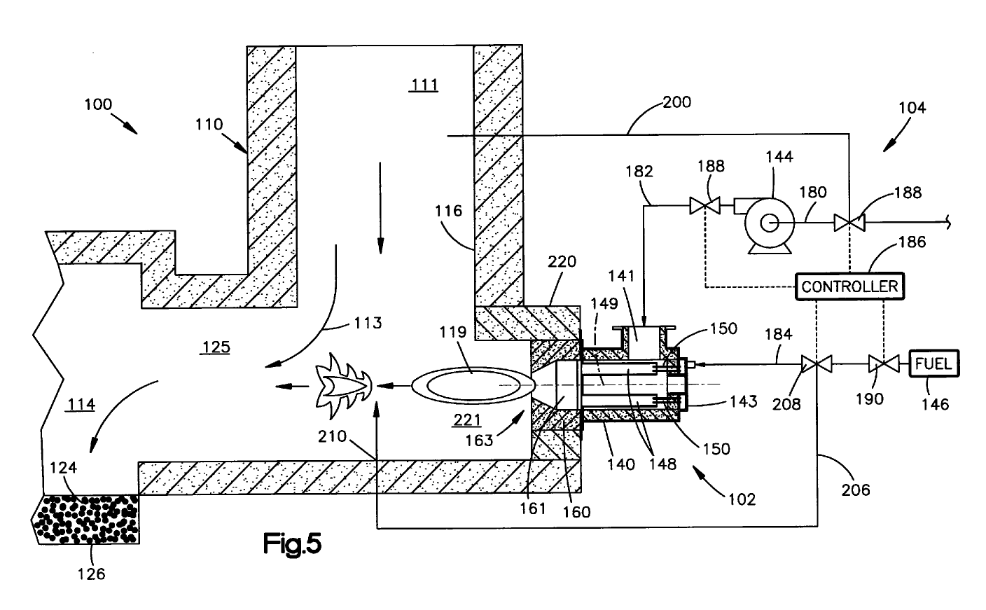

The embodiment of FIG. 5 also reduces the efficiency penalty caused by the premix in the embodiment of FIG. 3. In this embodiment, the reactant supply and control system 104 includes a fuel branch line 206 with a control valve 208. As shown schematically, the branch line 206 terminates at a fuel injection port 210 that is spaced axially downstream from the burner 102. The reactant supply and control system 104 is thus configured to supply primary fuel gas and combustion air to the premix burner 102, and to separately inject second stage fuel gas into the downcomer 110 without combustion air. The controller 186 is preferably configured to operate the valves 188, 190 and 208 such that primary fuel and combustion air are delivered to the burner 102 in amounts that form premix having a lean fuel-to-oxidant ratio, while simultaneously providing the branch line 206 with second stage fuel in an amount that is stoichiometric with the premix supplied to the burner 102. Since the premix in this embodiment includes less than the total target rate of fuel, it can include a correspondingly lesser amount of unheated air to establish a lean fuel-to-oxidant ratio. The lesser amount of unheated air in the premix causes a lower efficiency penalty.

An additional NOₓ suppression feature of the invention appears in FIG. 5 where the downcomer 110 is shown to have a recessed wall portion 220. This portion 220 of the downcomer 110 defines a combustion zone 221 that is recessed from the vertical passage 111. The burner 102 is mounted on the recessed wall portion 220 of the downcomer 110 so as to inject premix directly into the combustion zone 221 rather than directly into the vertical passage 111.

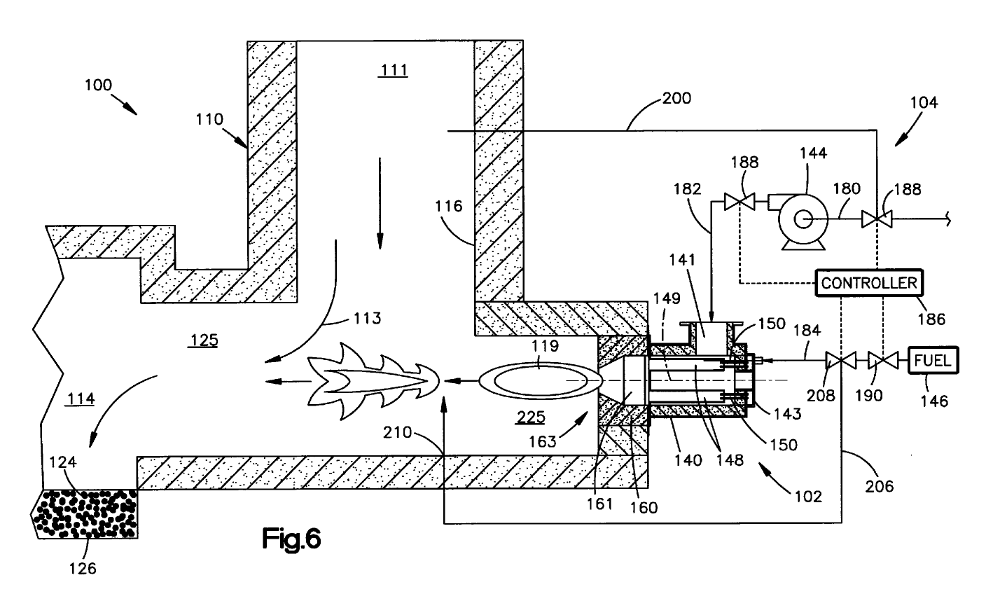

In the embodiment of FIG. 5, the premix flame 119 projects fully through the combustion zone 221 and into the vertical passage 111. The controller 186 could provide the burner 102 with fuel and combustion air at lower flow rates to cause the premix flame 119 to project only partially through the combustion zone 221 and thereby to produce less interaction NOₓ in the vertical passage 111. As shown in FIG. 6, a deeper combustion zone 225 could have the same effect without reducing the reactant flow rates.

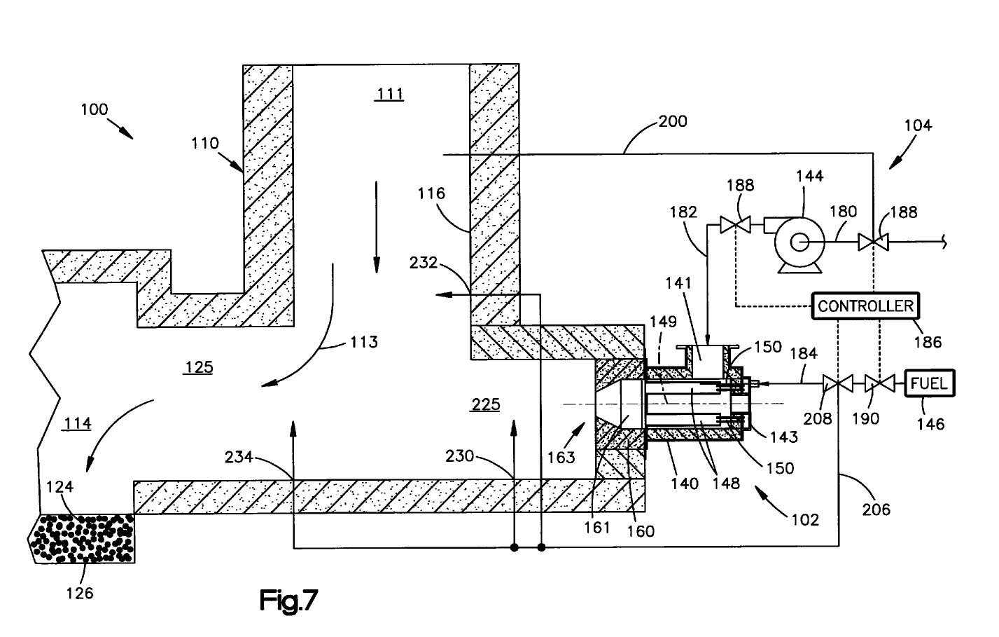

Additional suppression of interaction NOₓ can be achieved with differently staged fuel injection ports along with a recessed combustion zone. As shown for example in FIG. 7, these may include a port 230 for injecting staged fuel directly into the recessed combustion zone 225, a port 232 for injecting staged fuel directly into the vertical passage 111 upstream of the recessed combustion zone 225, and a port 234 for injecting staged fuel into the vertical passage 111 at a location downstream of the recessed combustion zone 225.

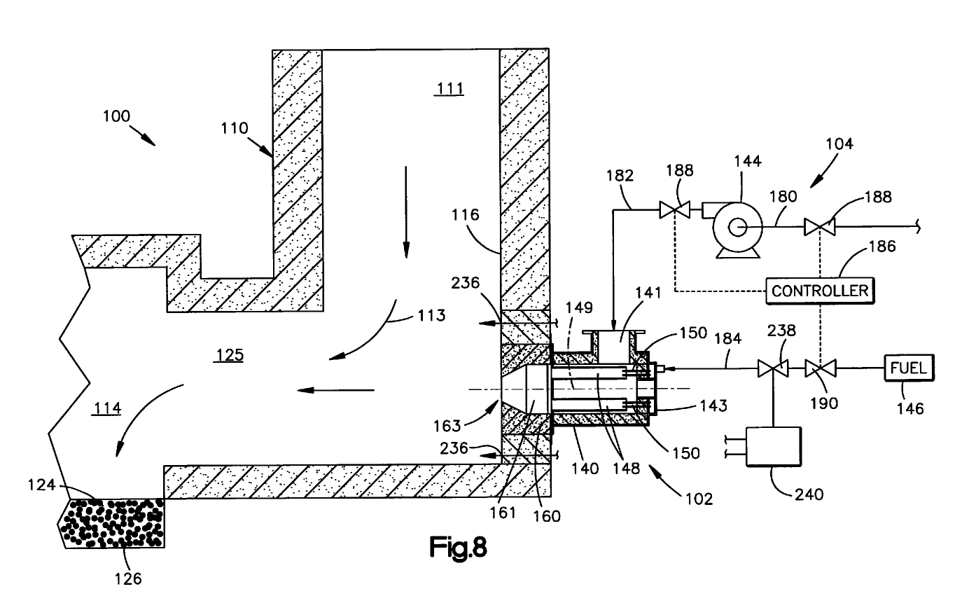

The embodiment of FIG. 8 has another alternative arrangement of staged fuel injector ports 236. These ports 236 are all arranged on the downcomer wall 116 in positions spaced radially from the burner port 163, and are preferably arranged in a circular array centered on the burner axis 149. The reactant supply and control system 104 includes a staged fuel control valve 238 for diverting fuel to a manifold 240 that distributes the diverted fuel to each port 236 equally. The ports 236 together inject that fuel into the downcomer 110 in a circular array of second stage streams. The ports 236 may be configured to inject the second stage fuel streams in directions that are parallel to and/or inclined toward the axis 149.

The temperature of the preheated air in the downdraft 113 is typically expected to be in the range of 1,500 to 2,000 degrees F., which is above the auto-ignition temperature of the fuel gas. For natural gas, the auto-ignition temperature is typically in the range of 1,000 to 1,200 degrees F. Therefore, in the embodiments of FIGS. 4-7, which use preheated downdraft air along with ambient air to form premix with the fuel gas, the downdraft air is mixed with the ambient air before being mixed with the fuel gas. This cools the downdraft air to a temperature below the auto-ignition temperature to prevent the fuel from igniting inside the mixer tubes 146 before the premix enters the downcomer 110.

The pelletizing process typically requires temperatures approaching 2,400-2,500 degrees F. These processing temperatures at the heating stations 114 could be provided by combustion with peak flame temperatures of 2,500-2,800 degrees F. in the adjacent downcomers 110. These peak flame temperatures could be maintained by combustion of natural gas and preheated air of 1,500-2,000 degrees F. and 200%-600% excess air. Preheated air of that temperature and amount is available in the downdrafts 113. However, since the downdraft air temperature of 1,500-2,000 degrees F. is higher than the auto-ignition temperature, the downdraft air can not form an unignited premix in the burners 102 if it is not first mixed with cooler air as noted above regarding FIGS. 4-7.

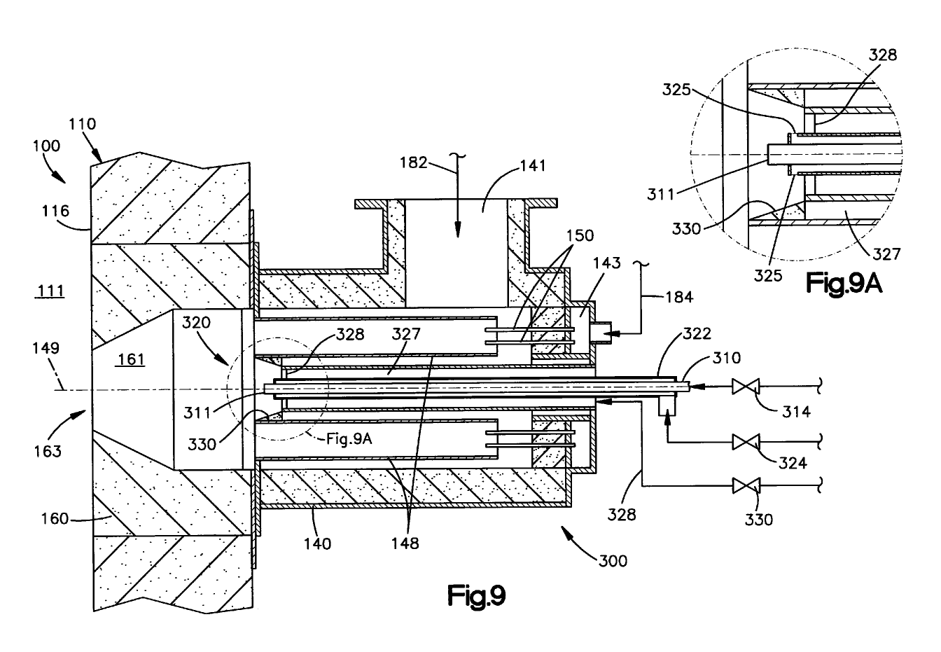

In the embodiment shown in FIG. 9, the furnace 100 includes an alternative premix burner 300. This burner 300 has many parts that are the same or substantially the same as corresponding parts of the burner 102 described above, and such parts are indicated by the same reference numbers in the drawings. The burner 300 thus has a rear portion 140 defining an oxidant plenum 141 and a fuel plenum 143. The oxidant plenum 141 receives combustion air from the oxidant duct 182. The fuel plenum 143 receives fuel gas from the fuel line 184.

Like the burner 102, the burner 300 has mixer tubes 148 that are preferably arranged in a circular array centered on a longitudinal axis 149. The mixer tubes 148 receive streams of combustion air from the oxidant plenum 141 and streams of fuel from fuel conduits 150 reaching from the fuel plenum 143. An outer portion 160 of the burner 300 defines a reaction zone 161 with an outlet port 163 to the downcomer passage 111. The premix is injected from the open outer ends of the mixer tubes 148 into the reaction zone 161.

The burner 300 of FIG. 9 also includes a secondary fuel line 310 with an outlet port 311 centered on the axis 149. The outlet port 311 is preferably provided as a high pressure nozzle, which may have any suitable configuration known in the art. The controller 186 is configured to operate a fuel supply valve 314 for the secondary fuel line 310 as described above.

The burner 300 further includes a radial flame burner 320 that is located concentrically between the secondary fuel outlet port 311 and the surrounding array of mixer tubes 148. The radial flame burner 320 can function as a combustion anchor structure as described in U.S. Pat. No. 6,672,862, which is incorporated by reference.

The radial flame burner 320 has a radial fuel line 322 reaching concentrically over the secondary fuel line 310. A valve 324 supplies the radial fuel line 322 with fuel gas under the influence of the controller 186. As shown in enlarged detail in FIG. 9A, the outer end portion of the radial fuel line 322 has fuel ports 325 that face radially outward. A radial combustion air passage 327 reaches concentrically over the radial fuel line 322. A spin plate 328 is located at the outer end of the passage 327, and a surrounding refractory surface 330 is tapered outwardly from the passage 327.

In operation of the embodiment of FIG. 9, a premix of primary fuel and primary combustion air is injected from the mixer tubes 148 into the reaction zone 161. Radial fuel is injected from the ports 325 into the reaction zone 161 in radially outward directions. Radial combustion air is injected from the passage 327 into the reaction zone 161 through the spin plate 328, which induces a swirl that carries the radial fuel and combustion air radially outward across the tapered refractory surface 330 toward the injected streams of premix. Combustion of those reactants in the reaction zone 161 then provides combustion products including vitiated combustion air.

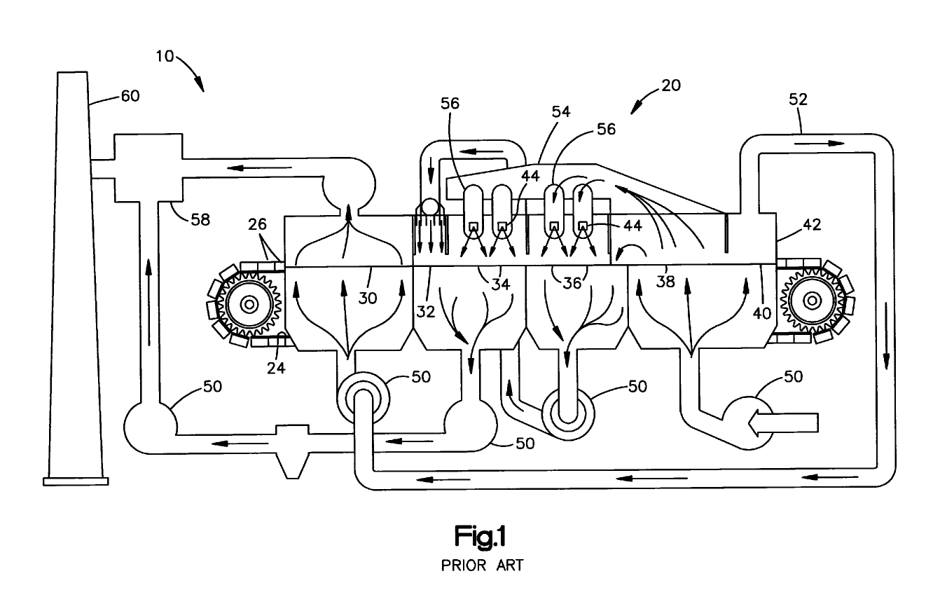

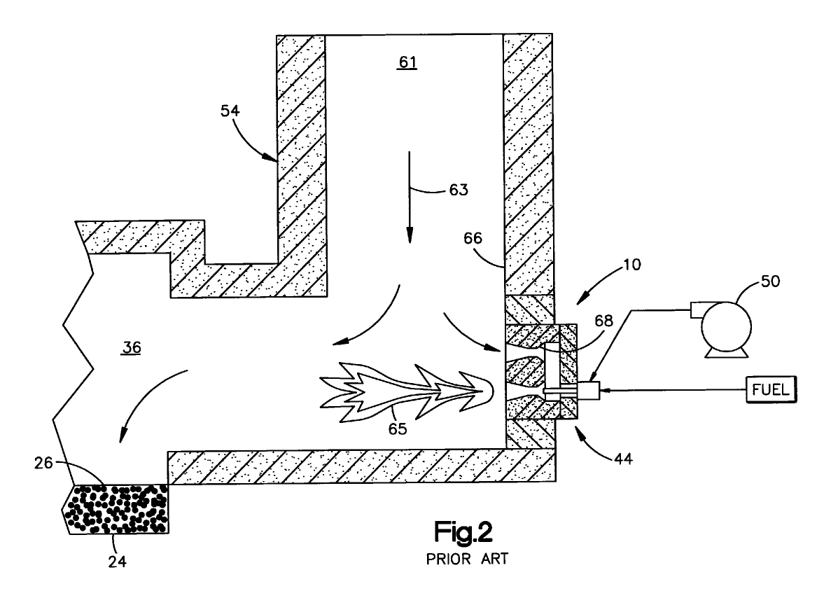

Secondary fuel is injected from the secondary fuel outlet port 311 in a jet reaching axially across the reaction zone 161. The secondary fuel mixes with the vitiated combustion air in the reaction zone 161. Combustion then proceeds as the contents of the reaction zone 161 move toward and through the outlet port 163 to the downcomer passage 111. Because the secondary fuel mixes with vitiated combustion air in the reaction zone 161 before interacting with the downdraft 113, further combustion of secondary fuel in the downdraft 113 produces less NOx than it would if the secondary fuel were injected directly into the downdraft 113 as described above with reference to the embodiments of FIGS. 1-8.

The radial flame burner 320 typically will account for 1% to 3% of the total fuel supplied to the burner 300 except when the burner 300 is firing at high turndown (typically 25% or less of maximum firing rate), in which case the proportion of the total fuel supplied by the radial flame burner 320 can be higher. In the best mode of operation, the proportion of the total fuel supplied in premix, or primary, fuel will be in a fuel-lean ratio with the combustion air, and will result in a calculated premix adiabatic flame temperature in the range of 2600 to 3400° F. The balance of the fuel, which will typically be sufficient, when added to the primary and radial fuel as secondary fuel, to provide a stoichiometric ratio between the total fuel and the air supplied to the burner 10.

The controller 186 can be further configured to operate the burner 300 of FIG. 9 in a mode in which some of the secondary fuel is supplied at the radial flame burner 320 instead of the secondary fuel line 310. The reaction zone 161 would then be supplied with a total amount of fuel in four portions including a portion of primary fuel at the mixer tubes 148, a portion of fuel sufficient to perform the anchoring function at the radial flame burner 320, a portion of secondary fuel that also is injected radially from the radial flame burner 320, and the remaining balance of the total amount as a portion of secondary fuel that is injected axially from the port 311.

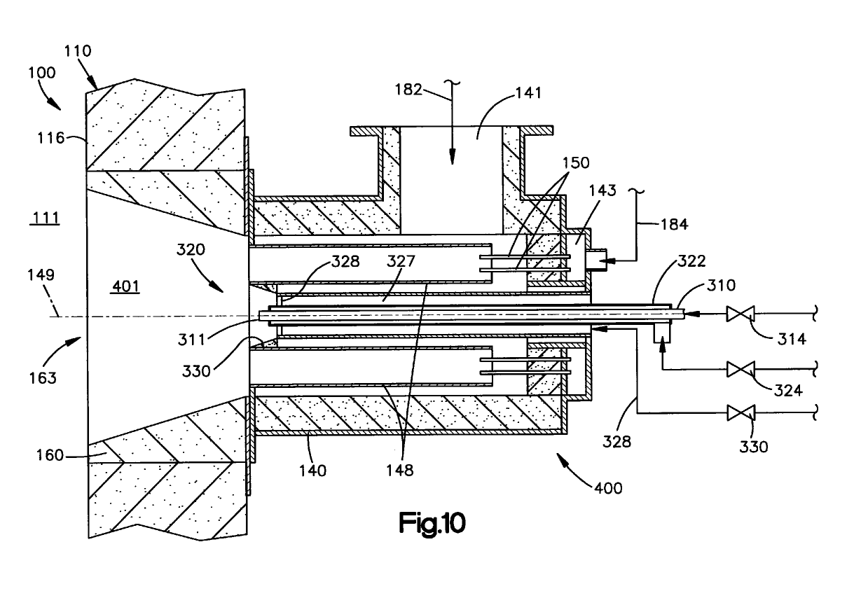

In the embodiment of FIG. 10, the indurating furnace 100 is equipped with a premix burner 400 that differs from the premix burner 300 of FIG. 9 by having a reaction zone 401 that is tapered radially outward, whereas the reaction zone 161 is tapered radially inward.

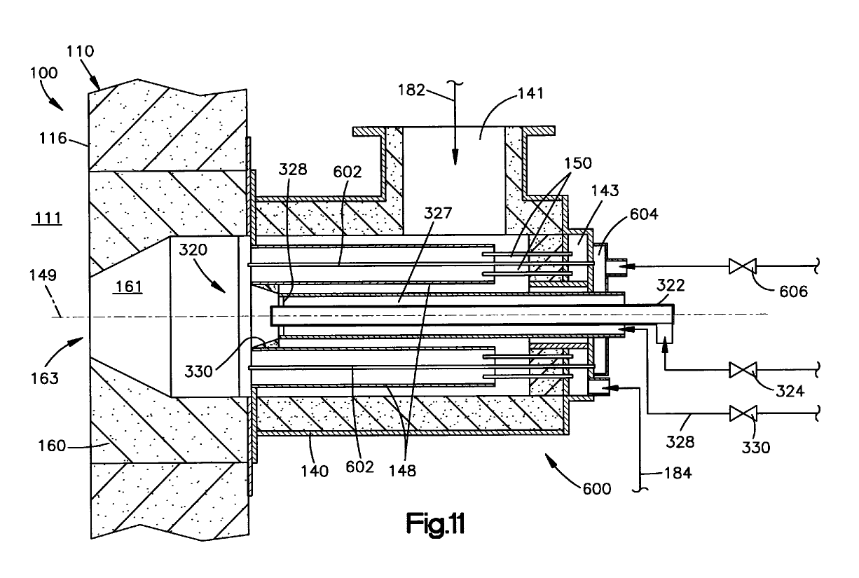

In the embodiment of FIG. 11, the indurating furnace 100 is equipped with a premix burner 600 that differs from the premix burner 300 of FIG. 9 by having multiple secondary fuel injectors 602, each of which is located concentrically within a respective mixer tube 148. Each mixer tube 148 is supplied with primary fuel by the premix fuel conduits 150 reaching from the premix fuel plenum 143. In the illustrated embodiment, the secondary fuel injectors 602 are supplied with fuel from a separate fuel plenum 604. A secondary fuel valve 606 is operated by the controller 186 to supply the separate plenum 604 with secondary fuel separately from the primary fuel supplied to the premix fuel plenum 143. Alternatively, the secondary fuel injectors 602 could be supplied with fuel from the premix fuel plenum 143.

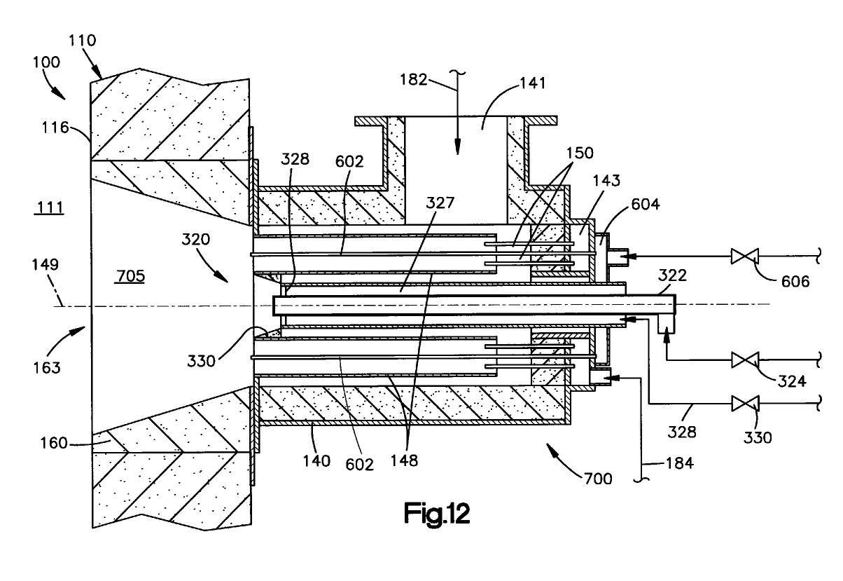

The premix burner 700 of FIG. 12 differs from the premix burner 600 of FIG. 11 by having a reaction zone 705 that is tapered radially outward, whereas the reaction zone 161 in the burner 600 is tapered radially inward.

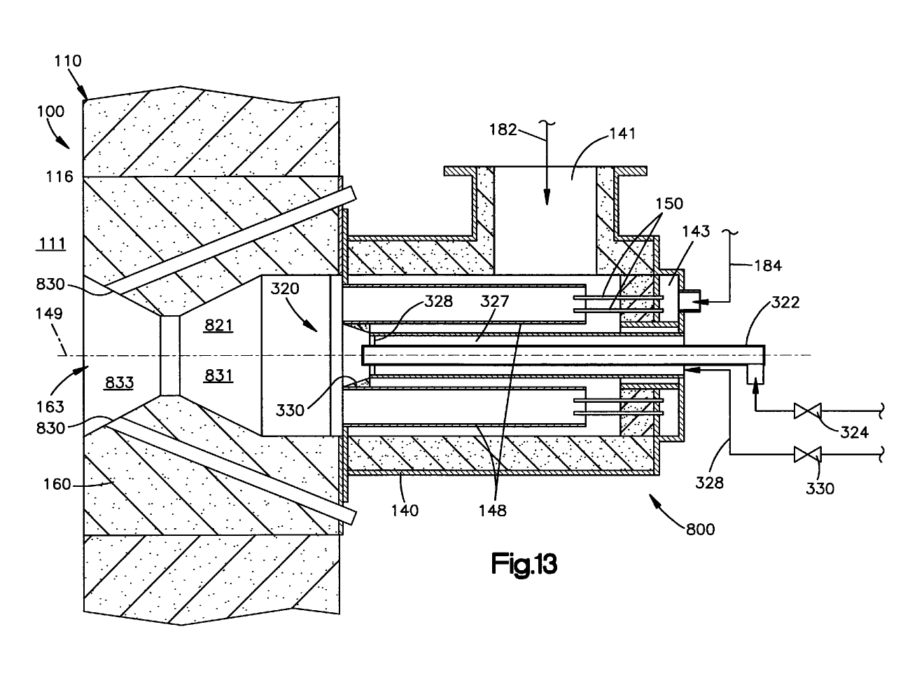

The burner apparatus 800 of FIG. 13 incorporates a converging/diverging two-stage reaction zone 821 and one or more secondary fuel injectors 830. A portion of the fuel and all of the burner combustion air (except for a very small fraction of the burner air supplied to the radial burner) are premixed in the mixer tubes 148. The portion of the fuel provided as premix (also called primary fuel) will be in a fuel-lean ratio with the burner combustion air, and will mostly combust in a primary combustion zone in the converging section 831 of the reaction zone 821. The products of combustion from the lean premix will exit the converging section 831, and enter the second, diverging stage 833 of the reaction zone 830. The diverging section 833 of the reaction zone 821 may be configured to minimize the ingress of furnace atmosphere with high oxygen content from the downcomer passage 111 by incorporating a divergent taper of 20 to 30 degree included angle. Secondary fuel may be introduced through the secondary fuel injectors 830 near the exit of the diverging section 833 of the reaction zone 821. This configuration will help to minimize NOx by introducing the secondary fuel into the low-oxygen products of combustion from the premix fuel while helping to avoid high refractory temperatures which might be caused by combustion of near stoichiometric quantities of total fuel with preheated combustion air if the secondary fuel were introduced in the converging section 831 of the reaction zone 821.

This written description sets forth the best mode of carrying out the invention, and describes the invention so as to enable a person skilled in the art to make and use the invention, by presenting examples of elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they have equivalent elements with insubstantial differences from the literal language of the claims.

1. A method for achieving low NOx combustion of fuel gas in heated pelletizing process air, comprising:
conveying pelletized material through an indurating furnace having a heating station and a passage that directs heated process air to the heating station;
driving heated process air through the passage toward the heating station; and
operating a premix burner having a reaction zone with an outlet to the passage, including the steps of:
injecting a premix of primary fuel gas and combustion air into the reaction zone;
combusting the premix to provide combustion products including vitiated combustion air in the reaction zone;
injecting staged fuel gas into the reaction zone separately from the premix;
discharging the staged fuel gas and vitiated combustion air from the reaction zone through the outlet to the passage; and
combusting the staged fuel gas and vitiated combustion air in the heated process air in the passage, whereby low NOx combustion in the heated process air can be achieved as a result of interacting the staged fuel gas with the vitiated combustion air in the reaction zone.

2. A method as defined in claim 1 wherein the premix is injected into the reaction zone in a fuel lean condition, whereby excess combustion air in the premix is available for vitiation in the reaction zone.

3. A method as defined in claim 1 wherein the reaction zone has a central axis, and staged fuel gas is injected into the reaction zone as a jet centered on the axis.

4. A method as defined in claim 1 wherein the staged fuel gas is injected into the reaction zone from a high pressure nozzle.

5. A method as defined in claim 1 wherein the premix is injected into the reaction zone from a mixer tube, and the staged fuel gas is injected into the reaction zone from a staged fuel injector located within the mixer tube.

6. A method as defined in claim 1 wherein the staged fuel gas is injected into the reaction zone in a direction radially inward toward the axis.

7. A method for achieving low NOx combustion of fuel gas in a furnace combustion chamber, comprising:
delivering fuel gas to the furnace combustion chamber from a premix burner having a reaction zone with an outlet to the furnace combustion chamber, including the steps of:
injecting a premix of primary fuel gas and combustion air into the reaction zone;
injecting radial fuel gas into the reaction zone in a direction radially outward from an axis;
combusting the premix and the radial fuel gas to provide combustion products including vitiated combustion air in the reaction zone;
injecting staged fuel gas into the reaction zone separately from the premix and the radial fuel gas;
discharging the staged fuel gas and vitiated combustion air from the reaction zone through the outlet to the furnace combustion chamber; and
combusting the staged fuel gas and vitiated combustion air in the furnace combustion chamber, whereby low NOx combustion in the furnace combustion chamber can be achieved as a result of interacting the staged fuel gas with the vitiated combustion air in the reaction zone.

8. A method as defined in claim 7 wherein the premix is injected into the reaction zone in a fuel lean condition, whereby excess combustion air in the premix is available for vitiation in the reaction zone.

9. A method as defined in claim 7 wherein the staged fuel gas is injected into the reaction zone as a jet centered on the axis.

10. A method as defined in claim 7 wherein the staged fuel gas is injected into the reaction zone from a high pressure nozzle.

11. A method as defined in claim 7 wherein the premix is injected into the reaction zone from a mixer tube, and the staged fuel gas is injected into the reaction zone from a staged fuel injector located within the mixer tube.

12. A method as defined in claim 7 wherein the staged fuel gas is injected into the reaction zone in a direction radially inward toward the axis.

13. A method for achieving low NOx combustion in heated pelletizing process air, comprising:
conveying pelletized material through an indurating furnace having a heating station and a passage that directs heated process air to the heating station;
driving heated process air through the passage toward the heating station; and
operating a premix burner having a reaction zone with an outlet to the passage, including the steps of:
injecting a premix of primary fuel gas and combustion air into the reaction zone;
injecting radial fuel gas into the reaction zone in a direction radially outward from an axis;
combusting the premix and the radial fuel gas in the reaction zone to provide combustion products including vitiated combustion air in the reaction zone;
injecting staged fuel gas into the reaction zone separately from the premix and the radial fuel gas;
discharging the staged fuel gas and vitiated combustion air from the reaction zone through the outlet to the passage; and
combusting the staged fuel gas and vitiated combustion air in the heated process air in the passage, whereby low NOx combustion in the heated process air can be achieved as a result of interacting the staged fuel gas with the vitiated combustion air in the reaction zone.

14. A method as defined in claim 12 wherein the premix is injected into the reaction zone in a fuel lean condition, whereby excess combustion air in the premix is available for vitiation and interaction with the secondary fuel gas in the reaction zone.

15. A method as defined in claim 12 wherein the staged fuel gas is injected into the reaction zone in a jet centered on the axis.

16. A method as defined in claim 12 wherein the staged fuel gas is injected into the reaction zone from a high pressure nozzle.

17. A method as defined in claim 12 wherein the premix is injected into the reaction zone from a mixer tube, and the staged fuel gas is injected into the reaction zone from a staged fuel injector located within the mixer tube.

18. A method as defined in claim 12 wherein the staged fuel gas is injected into the reaction zone in a direction radially inward toward the axis.

19. An apparatus for achieving low NOx combustion in heated pelletizing process air, comprising:
an indurating furnace structure defining a heating station, a conveyor that conveys pelletized material to the heating station, and a passage that directs heated pelletizing process air to the heating station;
sources of primary fuel gas, combustion air, and staged fuel gas; and
a premix burner having:
a structure defining a reaction zone with an outlet to the passage;
a mixer tube having an inlet that receives primary fuel gas and combustion air from the respective sources, and having an outlet that discharges a premix of the primary fuel gas and combustion air into the reaction zone; and
a staged fuel injector that receives staged fuel gas from the respective source, and that injects the staged fuel gas into the reaction zone separately from the premix, whereby the staged fuel gas can interact with vitiated combustion air in the reaction zone to produce low NOx combustion in heated process air in the passage.

20. An apparatus as defined in claim 19 wherein the reaction zone has a central axis, and the staged fuel injector is centered on the axis.

21. An apparatus as defined in claim 19 wherein the staged fuel injector has a high pressure nozzle.

22. An apparatus as defined in claim 19 wherein the staged fuel injector is located within the mixer tube.

23. An apparatus as defined in claim 19 wherein the reaction zone has an inner end wall and a peripheral wall, and the staged fuel injector is located at a peripheral wall of the reaction zone.

24. An apparatus as defined in claim 19 wherein the reaction zone has a converging section into which the mixer tube and radial flame burner discharge reactants, and has a diverging zone having the outlet to the passage, and the staged fuel injector injects the staged fuel gas into the diverging section of the reaction zone.

25. An apparatus for achieving low NOx combustion of fuel gas in a furnace combustion chamber, comprising:
sources of primary fuel gas, combustion air, radial fuel gas, and staged fuel gas;
a burner structure defining a reaction zone with an outlet to the furnace combustion chamber;
a mixer tube having an inlet that receives primary fuel gas and combustion air from the respective sources, and having an outlet that discharges a premix of the primary fuel gas and combustion air into the reaction zone;
a radial flame burner that receives radial fuel gas and combustion air from the respective sources, and that fires into the reaction zone; and
a staged fuel injector that receives staged fuel gas from the respective source, and that injects the staged fuel gas into the reaction zone separately from the premix and the radial fuel, whereby the staged fuel gas can interact with vitiated combustion air in the reaction zone to produce low NOx combustion in the furnace combustion chamber.

26. An apparatus as defined in claim 25 wherein the staged fuel injector is centered on a central axis of the radial flame burner.

27. An apparatus as defined in claim 25 wherein the staged fuel injector has a high pressure nozzle.

28. An apparatus as defined in claim 25 wherein the staged fuel injector is located within the mixer tube.

29. An apparatus as defined in claim 25 wherein the reaction zone has an inner end wall and a peripheral wall, and the staged fuel injector is located at a peripheral wall of the reaction zone.

30. An apparatus as defined in claim 25 wherein the reaction zone has a converging section into which the mixer tube and radial flame burner discharge reactants, and has a diverging zone having the outlet to the furnace combustion chamber, and the staged fuel injector injects the staged fuel gas into the diverging section of the reaction zone.

31. An apparatus for achieving low NOx combustion in heated pelletizing process air, comprising:
an indurating furnace structure defining a heating station, a conveyor to convey pelletized material to the heating station, and a passage to direct heated pelletizing process air to the heating station;
sources of primary fuel gas, combustion air, radial fuel gas, and staged fuel gas; and
a premix burner having:
a structure defining a reaction zone with an outlet to the passage;
a mixer tube having an inlet that receives primary fuel gas and combustion air from the respective sources, and having an outlet that discharges a premix of the primary fuel gas and combustion air into the reaction zone;
a radial flame burner that receives radial fuel gas and combustion air from the respective sources, and that fires into the reaction zone; and
a staged fuel injector that receives staged fuel gas from the respective source, and that injects the staged fuel gas into the reaction zone separately from the premix and the radial fuel gas, whereby the staged fuel gas can interact with vitiated combustion air in the reaction zone to produce low NOx combustion in the furnace combustion chamber.

32. An apparatus as defined in claim 31 wherein the staged fuel injector is centered on a central axis of the radial flame burner.

33. An apparatus as defined in claim 31 wherein the staged fuel injector has a high pressure nozzle.

34. An apparatus as defined in claim 31 wherein the staged fuel injector is located within the mixer tube.

35. An apparatus as defined in claim 31 wherein the reaction zone has an inner end wall and a peripheral wall, and the staged fuel injector is located at a peripheral wall of the reaction zone.

36. An apparatus as defined in claim 31 wherein the reaction zone has a converging section into which the mixer tube and radial flame burner discharge reactants, and has a diverging zone having the outlet to the passage, and the staged fuel injector injects the staged fuel gas into the diverging section of the reaction zone.
